(19) United States
(12) Patent Application Publication
(10) Pub. No.: US 2003/0002390 A1
(43) Pub. Date: Jan. 2, 2003

(54) Electronic reminders

(76) Inventors: Abigail Jane Sellen, Newbury (GB); Rachel Lucy Murphy, Bristol (GB); Jeroen Geert Bijsmans, Oegstgeest (NL)

Correspondence Address: HEWLETT-PACKARD COMPANY, Intellectual Property Administration, P.O. Box 272400, Fort Collins, CO, 80527-2400, US

(21) Appl. No.: 10/184,170

(22) Filed: Jun. 27, 2002

(30) Foreign Application Priority Data
Jun. 30, 2001 (GB) 0116114.0

(51) Int. Cl. G04B 47/00; G04C 21/00

(52) U.S. Cl. 368/12; 368/73

(57) ABSTRACT

A method of reminding a user of a forthcoming event, the method being performed by a processor and comprising the steps of: (a) acquiring the time when the forthcoming event is due to occur; (b) acquiring a user-selected digital image associated with the said forthcoming event; (c) storing the digital image in a digital image storage device; and (d) displaying the said digital image before the user a predetermined time period in advance of the said time when the said forthcoming event is due to occur, in order to remind the user of the said forthcoming event.

This invention relates to a method of reminding people of diary dates and appointments.

### BACKGROUND OF THE INVENTION

People today lead busy lives with many commitments on their time. Business people have meetings and other appointments to attend, and important deadlines to keep. Other diary appointments which many people are required to remember include the birthdays of friends and family members, visits to the doctor or dentist, and other engagements such as weddings and anniversaries, or a visit from a tradesman such as a plumber.

Calendars and diaries are commonplace and their use is extensive. Electronic diaries and calendars such as Microsoft (RTM) Outlook (RTM), which may be run on a personal computer (PC) or a personal data assistant (PDA), are becoming increasingly popular, and offer a convenient means of handling appointments together with an automated system of alerting the user to forthcoming engagements.

Electronic diaries and calendars such as Outlook (RTM) are used so extensively that some people can be swamped with information reminding them of their appointments and diary dates. It is thereby possible to miss a truly important deadline if the relevant computer-generated reminder message is hidden amongst several other such messages pertaining to less-urgent matters. There is clearly a need for a striking and effective means, that cannot readily be overlooked, by which a user can be reminded of important diary dates.

It is a general object of the present invention to overcome or at least mitigate the problems identified above.

### SUMMARY OF THE INVENTION

According to a first aspect of the present invention there is provided a method of reminding a user of a forthcoming event, the method being performed by a processor and comprising the steps of: (a) acquiring the time when the forthcoming event is due to occur; (b) acquiring a user-selected digital image associated with the said forthcoming event; (c) storing the digital image in a digital image storage device; and (d) displaying the said digital image before the user a predetermined time period in advance of the said time when the said forthcoming event is due to occur, in order to remind the user of the said forthcoming event. This has the advantage that the format of the reminder, being an image, is more evocative, more noticeable, and less likely to be overlooked or forgotten than conventional text-based reminder messages.

Preferably step (b) of the method comprises acquiring a digital image using a digital camera. By using a digital photograph, possibly taken by the user himself, when the reminder image appears it serves as an effective trigger to the user's memory.

Alternatively step (b) of the method comprises acquiring a digital image from a database of digital images. This presents the advantage that the user need not take digital photographs himself to serve as reminder images. Often taking a digital photograph to be a reminder image may not be practical. Through using a database of images the user is able to choose his desired reminder image from a selection of images stored in the database. The database may be pre-prepared by a third party, comprising an archive of digital photographs and images, and/or may comprise digital photographs or images obtained by the user himself.

Preferably step (d) comprises displaying the said digital image on the display of a personal computer. For those that use a personal computer throughout their working day, this has the advantage that the reminder image will appear prominently and cannot be overlooked.

The said digital image may be displayed as the desktop image on the display of the said personal computer, thereby being highly prominent on the user's computer. Alternatively the said digital image may be displayed as a screensaver on the display of the said personal computer, thereby providing a reminder to the user which would be unlikely to be overlooked.

Alternative preferences are that step (d) comprises displaying the said digital image on the display of a personal data assistant, or on a digital display integral in a watch or in a mobile station (e.g. a mobile phone). These have the advantage that the device on which the reminder image is displayed is portable and (particularly in the case of a watch or a mobile phone) is often about the user's person and is frequently consulted. This helps to ensure that the reminder image is not overlooked by the user.

With respect to the above means for displaying a reminder image, preferably step (d) comprises fading the said digital image into and out of view. This has the advantage of attracting the attention of the user and helping to ensure that the reminder is noticed.

An alternative preference is that step (d) of the method comprises printing the said digital image using a printer. This has the advantage that the user is able to take a printed version of the reminder image with him, away from his PC. Particularly preferably the said printer prints onto self-adhesive labels. These can be affixed into prominent positions, thereby increasing the likelihood that the user will notice the reminder image and take the necessary action.

Preferably the time when a user-specific forthcoming event is due to occur, together with the user-selected image and information identifying the user for whom the said event is forthcoming, are stored in a database hosted on a server, and the user-specific database content is made available to the said user via a data communications network. Accordingly the reminder information may be stored centrally and made available to the user via means such as the Internet. This has the advantage that the information can be made available to any device connected to or accessible via the Internet, such as a home computer or a mobile device such as a PDA, a watch or a mobile telephone, such as described herein.

According to a second aspect of the present invention there is provided a watch comprising a processor, a digital image storage device and a display, the display being adapted to display digital images, the processor being configured to acquire the time when a forthcoming event is due to occur, to store a user-selected image associated with a forthcoming event, and to display the said image on the display a predetermined time period in advance of the said time when the forthcoming event is due to occur, in order to remind a user of the said forthcoming event. This advantageously is a portable device, worn and frequently consulted by the user, and the reminder images that appear will be unlikely to be overlooked by the user.

Preferably the watch further comprises digital communications means to enable it to receive, via a digital communications network, the time when the said forthcoming event is due to occur and a digital image associated with the said forthcoming event. This allows reminder images and the accompanying times to be readily transferred from a data source (e.g. a PC or a PDA) to the watch. Preferably the said digital communications means comprises a port into which an electrical cable can be inserted and electrically coupled, thereby enabling straightforward and cost-effective connection by cable (e.g. serial or USB) between the watch and the data source. Alternatively the said digital communications means are wireless, preferably operating using infra-red or radio frequency (preferably Bluetooth (RTM)) transmission. This has the advantage that an electrical connection need not be established between the watch and the data source, and also permits the transfer of reminder information to the watch via a wireless network (e.g. a mobile phone network).

According to a third aspect of the present invention there is provided a mobile station comprising a processor, a digital image storage device and a display, the display being adapted to display digital images, the processor being configured to acquire the time when a forthcoming event is due to occur, to store a user-selected image associated with a forthcoming event, and to display the said image on the display a predetermined time period in advance of the said time when the forthcoming event is due to occur, in order to remind a user of the said forthcoming event. Advantageously this is also a portable device which is often carried by the user, thereby increasing the likelihood that the reminder will be noticed and acted upon.

According to a fourth aspect of the present invention there is provided a calendar comprising a processor, a digital image storage device, a user interface and a display, the display being adapted to display digital images, the processor being operationally connected to the user interface, storage device and display, the calendar further comprising means to enable the processor to receive digital images and time data, the processor being configured to acquire the time when a forthcoming event is due to occur, to store a user-selected digital image associated with a forthcoming event, and to display the said image on the display in advance of the said time when the forthcoming event is due to occur, in order to remind a user of the said forthcoming event. The calendar, which is preferably wall-mounted, has the advantage that it enables the method of the present invention to be presented in a domestic article analogous to conventional calendars with which people are familiar.

Preferably the means to enable the processor to receive digital images comprises a digital camera integral in the calendar. By integrating a digital camera within the calendar this advantageously gives a single article which may be configured in accordance with the method of the present invention.

Preferably the means to enable the processor to receive time data comprises the said user interface.

Preferably the processor is further configured to display, on the said display, the said digital image together with an indication of the said time associated with the said event. Advantageously the calendar can present an array of dates on its display panel, typically in a monthly or weekly format, and can display a reminder image associated with a particular date alongside that date, or in a square on the calendar corresponding to that date. It will be appreciated that some such dates may be past yet still visible on the calendar display, in which case the associated image can serve as a reminder or memento of the event which has happened.

Preferably the user interface comprises either buttons or a touch panel, and advantageously the touch panel may be positioned over the display.

Accordingly, step (d) of the method in accordance with the first aspect of the invention alternatively preferably comprises displaying the said digital image on the display of a calendar in accordance with the fifth aspect of the invention.

According to a fifth aspect of the present invention there is provided a server comprising a database on which the time of a user-specific forthcoming event and an associated user-selected image are stored together with information identifying a user for whom the said event is forthcoming, the server further comprising means for sending the said digital image for presentation before the said user a predetermined time period in advance of the said time of the said forthcoming event, in order to remind the said user of the said forthcoming event.

According to a sixth aspect of the present invention there is provided a computer program for reminding a user of a forthcoming event, the program being executable to cause a processor to: (a) acquire the time when the forthcoming event is due to occur; (b) acquire a user-selected digital image associated with the said forthcoming event; (c) store the digital image in a digital image storage device; and (d) display the said digital image before the user a predetermined time period in advance of the said time when the said forthcoming event is due to occur, in order to remind the user of the said forthcoming event.

According to a seventh aspect of the present invention there is provided a computer program stored on a data carrier for reminding a user of a forthcoming event, the program being executable to cause a processor to: (a) acquire the time when the forthcoming event is due to occur; (b) acquire a user-selected digital image associated with the said forthcoming event; (c) store the digital image in a digital image storage device; and (d) display the said digital image before the user a predetermined time period in advance of the said time when the said forthcoming event is due to occur, in order to remind the user of the said forthcoming event.

### BRIEF DESCRIPTION OF THE DRAWINGS

Embodiments of the invention will now be described, by way of example, and with reference to the drawings in which:

FIG. 1 illustrates the steps of a method in accordance with the present invention;

FIG. 2 shows an example of interconnected electronic devices configured to operate in accordance with the present invention;

FIG. 3 shows another example of interconnected electronic devices configured to operate in accordance with the present invention;

FIG. 4 shows a watch in accordance with an aspect of the present invention; and

FIG. 5 shows a calendar in accordance with another aspect of the present invention.

### DETAILED DESCRIPTION OF THE PREFERRED EMBODIMENT

The term ‘reminder image’ used herein refers to images which an electronic processor causes to be displayed before a user to remind the user of a forthcoming diary date, an appointment, or another event of some kind. The appearance of the reminder image reminds the user of the appointment in question. The word ‘image’ used herein refers to a digital photograph or an abstract image selected by the user and chosen to be specific to the appointment in question. The word ‘image’ expressly does not refer to text or alphanumeric characters of any kind, thereby differentiating this invention from the text-based reminders provided by software such as Microsoft (RTM) Outlook (RTM). Since the image to be displayed is chosen by the user and is specific to a particular appointment, it will be appreciated that this concept is radically different to applications such as Outlook (RTM) which display a standard icon (e.g. an exclamation mark or an alarm bell) alongside a text-based reminder.

A reminder image could be a picture of a friend or relative, to be associated with that individual's birthday, or a picture of a colleague to remind the user of a business meeting, for example. It is envisaged that the user will adapt the concept to his own preferences and personal tastes, in order to ensure that the image serves as an effective reminder. To this end, the user may well use his sense of humour when choosing an image, selecting for example a picture of an animal to be associated with a particular relative's birthday.

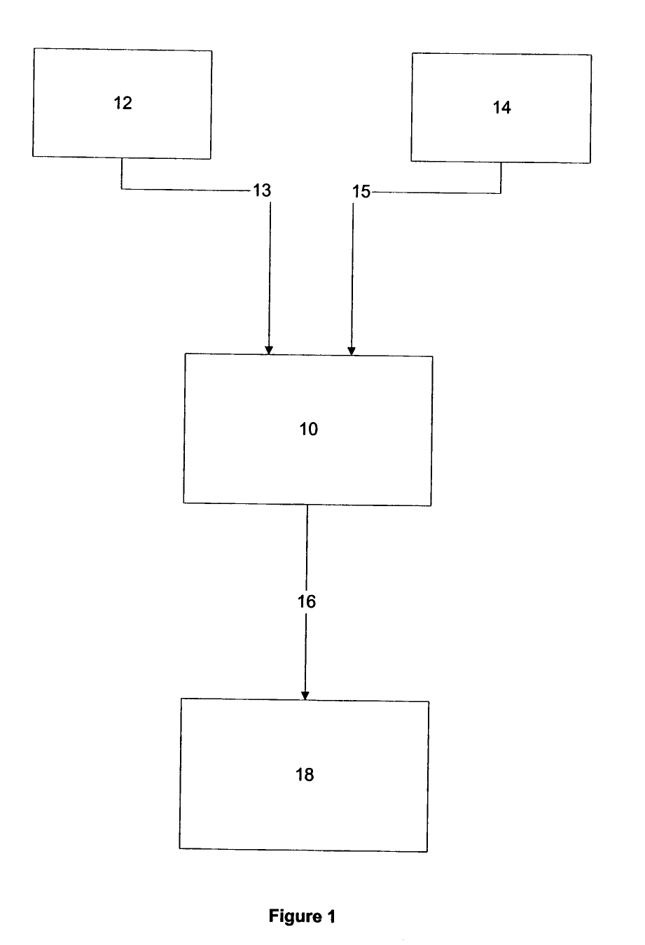

The method by which reminder images operate is as illustrated schematically in FIG. 1:

Step 1: The user supplies 13 to a computer processor 10 the time and/or date 12 when a forthcoming appointment is due to occur.

Step 2: The user supplies 15 to the processor 10 a digital image 14 associated with this forthcoming appointment.

The sequence of Steps 1 and 2 may be reversed.

Step 3: In advance of the time and/or date when this forthcoming appointment is due to occur, the computer processor 10 causes 16 the image 14 to be displayed 18 before the user.

The digital image supplied to the processor in Step 2 above is either obtained by the user using a digital camera, or the user may select a digital image from a database of digital images. In the latter case, the database may be the user's own image collection (e.g. stored on his PC or on a server) or may be provided by a third party (e.g. on a CD-ROM or via a server).

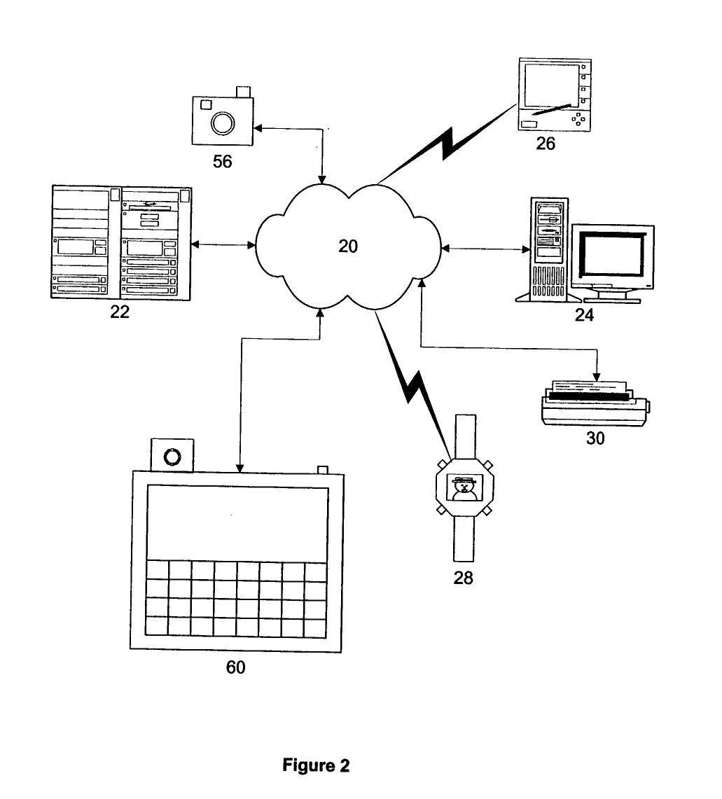

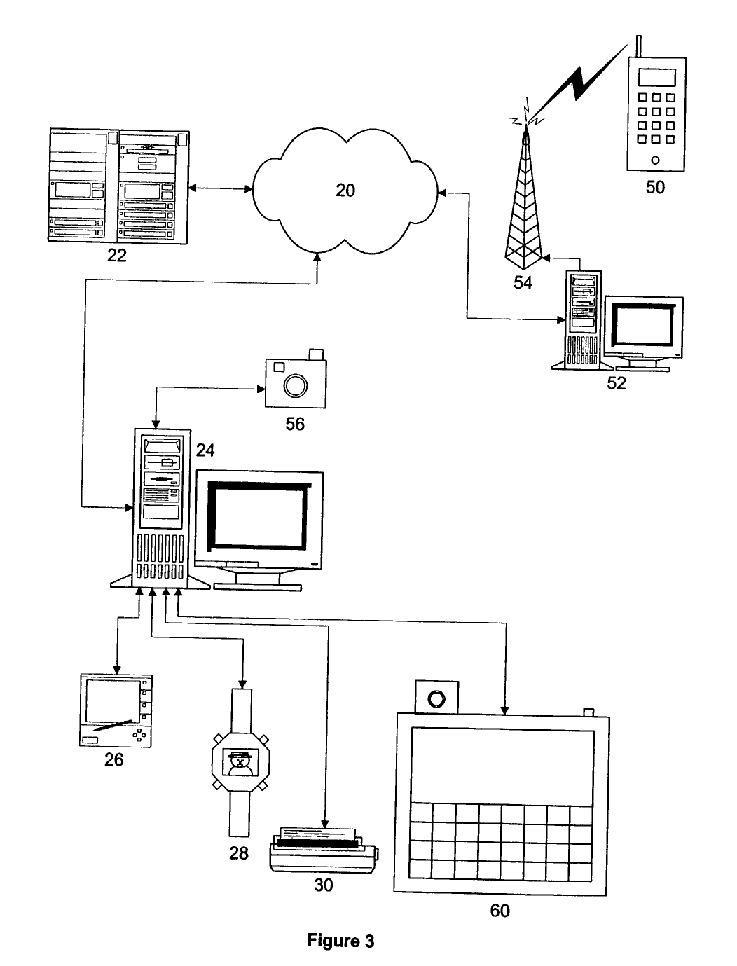

The above method may take place entirely within a user's desktop PC or his PDA, in which case it is provided by a suitable piece of software running on the PC or PDA. However, as illustrated in FIGS. 2 and 3, the method can advantageously be operated over a data communications network 20, serving a plurality of users. In this latter case, the time when a user-specific forthcoming event is due to occur may be stored in a database hosted on a server 22, together with the associated image and information identifying the user for whom the said event is forthcoming. This user-specific database content is then made available to the appropriate user via the network 20, which could be, for example, a local intranet or the Internet.

Should the user wish to take a digital photograph himself to serve as a reminder image, then he would use a digital camera 56. The digital photograph may then be transferred from the camera 56 to his PC 24 via a direct connection, as shown in FIG. 3. The photograph would either remain on this PC 24 or would then be transferred to the database hosted on the server 22 via the network 20. Alternatively, as shown in FIG. 2, the camera 56 could be connected directly to the network 20, provided the camera is equipped with suitable communications means such as a built-in modem.

A reminder image can be displayed on the display (e.g. the monitor) of a personal computer 24. The image, which appears at an appropriate time prior to the event for which it serves as a reminder, may fill all or part of the display, or may even appear just as a small icon in the taskbar. Alternatively the reminder image may be displayed as the PC's desktop image or as a screensaver. Software options are provided to enable the user to determine the format of the reminder images according to his personal preference.

The software may be made to be compatible with existing calendar software such as Outlook (RTM) and this would provide a straightforward way of supplying the processor with the desired image and informing it of the time and/or date of the appointment in question. For example, on sending the image from the camera 56 to the PC 24, a small ‘thumbnail’ representation of the image may be displayed on the PC's screen, and this thumbnail image could then be dragged by the user into the appropriate date square of a representation of a calendar also provided by the software and displayed on the screen. Alternatively the software could present the user with a ‘toolbox’ array of images corresponding to particular tasks, from which he could make his choice of reminder image. The user would also be able to add his own images to this toolbox array.

Other software-based means for setting up a reminder image are possible. For example, the date and/or time of an appointment could alternatively be set in the ‘Properties’ information associated with a chosen image. Another option would be for the user to double-click a date square in the on-screen calendar and for the software then to take him to a database of images from which he can choose his reminder image. A more advanced alternative is for the software to analyse text entered into the calendar software (e.g. “Mum's Birthday”) and then to search the user's database of images for a picture which has been pre-identified as being of the user's mother. The software can also be used to synchronise the reminder image information with the mobile devices as described below.

Reminder images may alternatively be displayed on a PDA 26. The details of the date and/or time of an appointment and the associated reminder image to be displayed may be entered directly into the PDA. Some PDAs have built-in (or attachable) digital cameras, which may be used to supply the digital image to the processor. Alternatively, as shown in FIG. 2, the required reminder image and the time of the appointment may be transferred to the PDA from a PC 24 via a network 20, potentially (but not necessarily) via a server 22. Alternatively, as shown in FIG. 3, the PDA 26 may be electrically coupled to a PC 24 via known means (e.g. by docking the PDA into a cradle connected to the PC by a USB or serial lead) and the reminder image information can then be transferred.

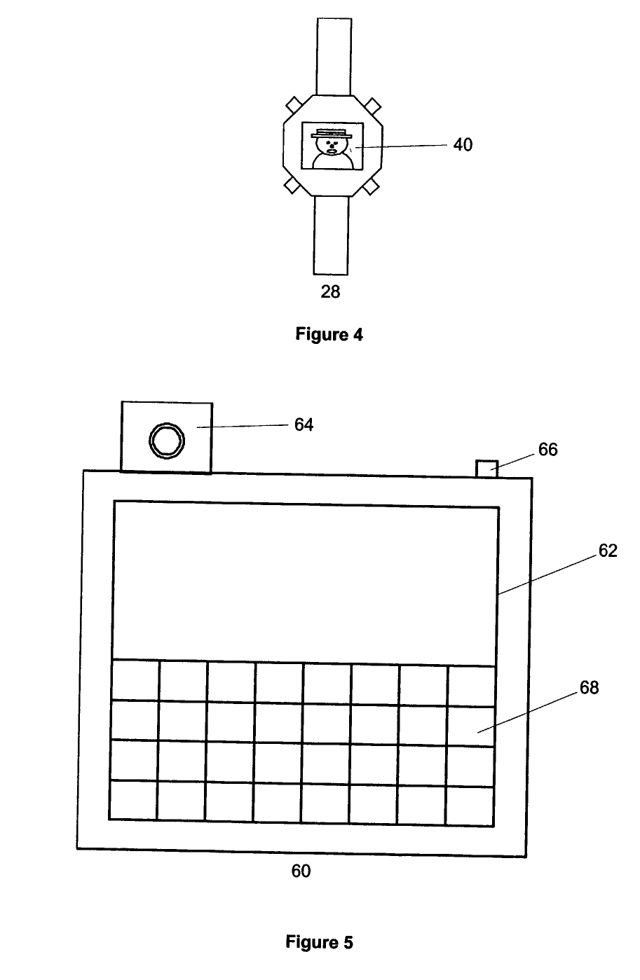

As shown in FIGS. 2, 3 and 4, reminder images may also be presented on a watch 28 having a display 40 (FIG. 4) capable of displaying graphical images and a processor configured to receive the time of a forthcoming event and the reminder image associated with that event, and then to display the reminder image in advance of the event. As shown in FIG. 2, the relevant data may be transferred to the watch 28 by electrically connecting it to a PC 24 using a serial or USB cable, in which case the watch 28 is provided with an appropriate port. Alternatively, as shown in FIG. 3, the watch 28 may be equipped with integral wireless telecommunications means to enable it to receive the relevant data via a wireless digital network.

Reminder images may also be displayed on a mobile station 50 (FIG. 3) such as a mobile telephone. Accordingly, the mobile station 50 has a display capable of displaying graphical images and a processor configured to receive the time of a forthcoming event and the reminder image associated with that event, and then to display the reminder image in advance of the event. The reminder images service may be provided by a mobile telecommunications operator, and the data is transmitted by the operator from a computer 52 via a base station and transmitter 54 to the mobile station 50.

To increase further the impact of the reminder images, they may be faded into and out of view on the display of any of the above display devices.

As illustrated in FIGS. 2 and 3, reminder images may be printed on a printer 30 connected to a PC 24 (FIG. 3) or directly connected to a network 20 (FIG. 2). The printing of reminder images may be performed on self-adhesive labels, thereby enabling the user to affix a printed image in a prominent place before him so as to ensure he does not forget about the associated event.

Another product designed to enable reminder images to be displayed is a calendar 60 as shown in FIGS. 2, 3 and 5. This calendar 60, which is preferably wall-mountable (but could alternatively be of a size and configuration to enable it to be stood on a desk) comprises a processor electrically coupled to a user interface and a display 62 (FIG. 5). In the preferred embodiment of this aspect of the invention the calendar comprises an integral digital camera 64 which can be operated by a user (pressing the button 66) to take a digital photograph which is supplied directly to the processor. This digital photograph will then serve as the reminder image.

The user utilises the calendar's user interface to supply the processor with the date and/or time of the event for which he would like his desired image to serve as a reminder. This user interface may comprise buttons, but is preferably a touch panel covering at least part of the display 62.

The display ordinarily displays an appropriately-labelled array of date squares 68 representing the days in a month (or alternatively just a week). A preferred method of operating the calendar is as follows:

Step 1: The user touches the touch panel on the representation of the date 68 for which he desires a reminder image—e.g for an appointment.

Step 2: The user places the subject of his reminder image before the camera 64 and presses the button 66 to cause a digital photograph of his subject to be taken.

The calendar may also be configured to replace the representation of days in a month with a representation of a computer keyboard, and by touching on the representations of keys the user is able to enter alphanumeric characters (e.g. to supply a file name to be associated with a photograph he has taken). However, this feature is by no means essential.

The calendar's processor is configured to display the appropriate reminder image (of Step 2 above) alongside the date, or in the appropriate date square 68, as previously chosen in Step 1 above. The processor can also be configured to display the image such that it occupies the entire (or a substantial proportion) of the area of the display 62 on or in advance of the date of the appointment, thereby providing a highly noticeable reminder.

It will be appreciated that some dates may pass yet will still visible on the calendar display, in which case the associated image can serve as a reminder or memento of the event which has happened.

As illustrated in FIGS. 2 and 3, the calendar 60 may be connected to a PC 24 (FIG. 3) or alternatively could be connected directly to a network 20 (FIG. 2), provided the calendar is equipped with suitable communications means such as a built-in modem. The user can thereby draw upon databases of images stored elsewhere, from which to select his reminder image. The chosen reminder image and details of the time and/or date of the appointment could also be stored elsewhere, for example on a PC 24 connected to the calendar 60 (FIG. 3) or on a server 22 (FIG. 2 or FIG. 3).

It is envisaged that reminder images would be reserved for special occasions, thereby making the images more poignant reminders than would be the case If they were used throughout each day. It is considered that their ability to remind a user of an appointment would be less effective if they were used as frequently as conventional text-based reminders. Since they are not intended for frequent use, it is unlikely that multiple images would be presented to the user on the same day. However, if it is ever necessary to display two or more images at the same time, the processor would be configured to alternate between the images being displayed.

1. A method of reminding a user of a forthcoming event, the method being performed by a processor and comprising the steps of:
(a) acquiring the time when the forthcoming event is due to occur;
(b) acquiring a user-selected digital image associated with the said forthcoming event;
(c) storing the digital image in a digital image storage device; and
(d) displaying the said digital image before the user a predetermined time period in advance of the said time when the said forthcoming event is due to occur, in order to remind the user of the said forthcoming event.

2. A method as claimed in claim 1 wherein step (b) comprises acquiring a digital image using a digital camera.

3. A method as claimed in claim 1 wherein step (b) comprises acquiring a digital image from a database of digital images.

4. A method as claimed in claim 1 wherein step (d) comprises displaying the said digital image on the display of a personal computer.

5. A method as claimed in claim 4 wherein the said digital image is displayed as the desktop image on the display of the said personal computer.

6. A method as claimed in claim 4 wherein the said digital image is displayed as a screensaver on the display of the said personal computer.

7. A method as claimed in claim 1 wherein step (d) comprises displaying the said digital image on the display of a personal data assistant.

8. A method as claimed in claim 1 wherein step (d) comprises displaying the said digital image on a digital display integral in a watch.

9. A method as claimed in claim 1 wherein step (d) comprises displaying the said digital image on a digital display integral in a mobile station.

10. A method as claimed in claim 1 wherein step (d) comprises fading the said digital image into and out of view.

11. A method as claimed in claim 1 wherein step (d) comprises printing the said digital image using a printer.

12. A method as claimed in claim 11 wherein the said printer prints onto self-adhesive labels.

13. A method as claimed in claim 1, wherein the time when a user-specific forthcoming event is due to occur, together with the user-selected image and information identifying the user for whom the said event is forthcoming, are stored in a database hosted on a server, and wherein the user-specific database content is made available to the said user via a data communications network.

14. A watch comprising a processor, a digital image storage device and a display, the display being adapted to display digital images, the processor being configured to acquire the time when a forthcoming event is due to occur, to store a user-selected image associated with a forthcoming event, and to display the said image on the display a predetermined time period in advance of the said time when the forthcoming event is due to occur, in order to remind a user of the said forthcoming event.

15. A watch as claimed in claim 14 further comprising digital communications means to enable it to receive, via a digital communications network, the time when the said forthcoming event is due to occur and the corresponding user-selected digital image.

16. A watch as claimed in claim 15 wherein the said digital communications means comprises a port for electrical connection with a cable.

17. A watch as claimed in claim 15 wherein the said digital communications means are wireless.

18. A mobile station comprising a processor, a digital image storage device and a display, the display being adapted to display digital images, the processor being configured to acquire the time when a forthcoming event is due to occur, to store a user-selected image associated with a forthcoming event, and to display the said image on the display a predetermined time period in advance of the said time when the forthcoming event is due to occur, in order to remind a user of the said forthcoming event.

19. A mobile station as claimed in claim 18, where said mobile station is a mobile to telephone.

20. A calendar comprising a processor, a digital image storage device, a user interface and a display, the display being adapted to display digital images, the processor being operationally connected to the user interface, storage device and display, the calendar further comprising means to enable the processor to receive digital images and time data, the processor being configured to acquire the time when a forthcoming event is due to occur, to store a user-selected digital image associated with a forthcoming event, and to display the said image on the display in advance of the said time when the forthcoming event is due to occur, in order to remind a user of the said forthcoming event.

21. A calendar as claimed in claim 20 wherein the means to enable the processor to receive digital images comprises a digital camera integral in the calendar.

22. A calendar as claimed in claim 20 wherein the means to enable the processor to receive time data comprises the said user interface.

23. A calendar as claimed in claim 20 wherein the processor is further configured to display, on the said display, the said digital image together with an indication of the said time associated with the said event.

24. A calendar as claimed in claim 20 wherein the said user interface comprises buttons.

25. A calendar as claimed in claim 20 wherein the said user interface comprises a touch panel.

26. A server comprising a database on which the time of a user-specific forthcoming event and an associated user-selected image are stored together with information identifying a user for whom the said event is forthcoming, the server further comprising means for sending the said digital image for presentation before the said user a predetermined time period in advance of the said time of the said forthcoming event, in order to remind the said user of the said forthcoming event.

27. A computer program for reminding a user of a forthcoming event, the program being executable to cause a processor to:
(a) acquire the time when the forthcoming event is due to occur;
(b) acquire a user-selected digital image associated with the said forthcoming event;
(c) store the digital image in a digital image storage device; and
(d) display the said digital image before the user a predetermined time period in advance of the said time when the said forthcoming event is due to occur, in order to remind the user of the said forthcoming event.

28. A computer program stored on a data carrier for reminding a user of a forthcoming event, the program being executable to cause a processor to:
(a) acquire the time when the forthcoming event is due to occur;
(b) acquire a user-selected digital image associated with the said forthcoming event;
(c) store the digital image in a digital image storage device; and
(d) display the said digital image before the user a predetermined time period in advance of the said time when the said forthcoming event is due to occur, in order to remind the user of the said forthcoming event.
